(19) United States
(12) Patent Application Publication
(10) Pub. No.: US 2014/0001664 A1
(43) Pub. Date: Jan. 2, 2014

(54) MATRIX BAND FOR DENTAL APPLICATIONS

(71) Applicant: Garrison Dental Solutions, Spring Lake, MI (US)

(72) Inventors: Robert W. Anderson, Coopersville, MI (US); Clarke D. Reberg, Holland, MI (US); Scott W. Doenges, West Olvie, MI (US)

(73) Assignee: Garrison Dental Solutions, Spring Lake, MI (US)

(21) Appl. No.: 14/014,497

(22) Filed: Aug. 30, 2013

Related U.S. Application Data
(63) Continuation of application No. 13/894,032, filed on May 14, 2013.
Application No. 13/894,032 is a division of application No. 12/586,341, filed on Sep. 21, 2009, now abandoned.

(51) Int. Cl. A61C 5/12

(52) U.S. Cl. CPC A61C 5/125
USPC 264/16

(57) ABSTRACT

A matrix band for dental applications including a base material and a coating. The base material has an outer surface and a tooth contact surface as well as a perimeter. The coating is applied to the tooth contact surface and extends to the perimeter of the tooth contact surface. The coating is a fluorinated ethylene propylene, polytetrafluoroethylene and polyether sulfone.

### BACKGROUND OF THE DISCLOSURE

1. Field of the Disclosure

The disclosure relates in general to matrix bands for dental applications, and more particularly, to a matrix band which is coated with a combination of polymers to provide enhanced properties.

2. Background Art

The use of matrix bands during tooth restoration is well known in the art. Matrix bands are typically positioned about a tooth during restoration. The matrix band provides an artificial wall when applying a filling material. One such band is often referred to as a Tofflemire band. Such a band comprises a stainless steel sheet that is positioned around a tooth. A tool, such as a band retainer is utilized to maintain the band in position. In other applications, smaller, shaped bands are utilized. One such band is shown in U.S. Pat. No. 5,788,487 issued to Meyer.

Inasmuch as the tooth restoration materials are designed to adhere to teeth, it is important to minimize the adhesion of the materials to the matrix bands. For this reason, a number of different materials and coatings have been applied to matrix bands to limit adhesion to the underlying tooth restoration resins. Among other coatings, particular metals and alloys, such as gold or tin, have been applied to the underlying stainless steel material. One such disclosure is seen in U.S. Pat. No. 6,749,429 issued to Haraden et al.

While certain references have identified the use of fluorocarbons (i.e. PTFE), problems have been identified. For example, U.S. Pub. No. 2009/0142725 has identified the use of fluorocarbons in association with dental matrix bands. However, others have attempted to utilize fluorocarbons in association with matrix bands without success. While fluorocarbons can be coated upon a base material, use in a matrix band results in de-lamination and scraping off of the fluorocarbon material. One such test is described in the above-described '429 patent at Example Six and Example Seven in Column 4 thereof.

The same has been observed through testing, with de-lamination occurring about the perimeter of the matrix band. In addition, such de-lamination only increases with shaped matrix bands. Thus, conventionally applied fluorocarbon materials have been found to be unsuitable for coating matrix bands.

### SUMMARY OF THE DISCLOSURE

It has been found that particular combinations of polymers, however, can yield coatings that are suitable for use in association with dental applications and matrix bands. Specifically, coatings comprising a combination of fluorinated ethylene propylene, polytetrafluoroethylene and polyether sulfone are suitable for use in association with matrix bands.

Thus, the present disclosure is directed to matrix bands for dental applications wherein the matrix band includes a base material and a coating. The base material has an outer surface and a tooth contact surface. The base material additionally defines a perimeter. The coating is applied to the tooth contact surface so as to extend to the perimeter thereof. The coating comprises a combination of fluorinated ethylene propylene, polytetrafluoroethylene and polyether sulfone.

In a preferred embodiment, the base material comprises a stainless steel.

In another preferred embodiment, the base material is selected from the group consisting of: polymers, metals and alloys thereof.

In another preferred embodiment, the base material has a base thickness, the base thickness is between 0.001 inches and 0.003 inches.

Preferably, the coating has a coating thickness which is between 0.00015 inches and 0.0006 inches.

In certain embodiments, the base material comprises a inwardly concave configuration which is stamped after the coating is applied to the tooth contact surface.

In other embodiments, the coating further includes a pigment selected from a number of pigments so as to allow for differentiation of matrix band properties based upon color.

In another aspect of the invention, the invention comprises a method of manufacturing a matrix band for dental applications comprising the steps of: (a) providing a base material; (b) coating the base material with a coating comprising fluorinated ethylene propylene, polytetrafluoroethylene and polyether sulfone; and (c) forming the base material into a desired configuration.

In a preferred embodiment, the step of coating comprises the steps of: (a) applying the coating to the base material; and (b) curing the coating onto the base material.

In another preferred embodiment, the step of coating further comprises the step of applying a coating to the base material in a thickness of between 0.00015 inches and 0.0006 inches.

In yet another preferred embodiment, the step of forming further comprises the step of stamping the base material into the desired shape and size.

In another preferred embodiment, the step of forming further comprises the step of cutting the base material into the desired shape and size.

### BRIEF DESCRIPTION OF THE DRAWINGS

The disclosure will now be described with reference to the drawings wherein:

FIG. 1 of the drawings comprises a front plan view of a matrix band of the present invention;

FIG. 2 of the drawings comprises a cross-sectional view of the matrix band of the present invention taken generally about lines 2-2 of FIG. 1;

FIG. 3 of the drawings comprises a cross-sectional view of the matrix band of the present invention taken generally about lines 3-3 of FIG. 1; and

FIG. 4 of the drawings is a front plan view of another matrix band of the present invention;

FIG. 5 of the drawings is a bottom elevational view of the matrix band of FIG. 4; and

FIG. 6 of the drawings is a side elevational view of the matrix band of FIG. 4 of the present invention.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

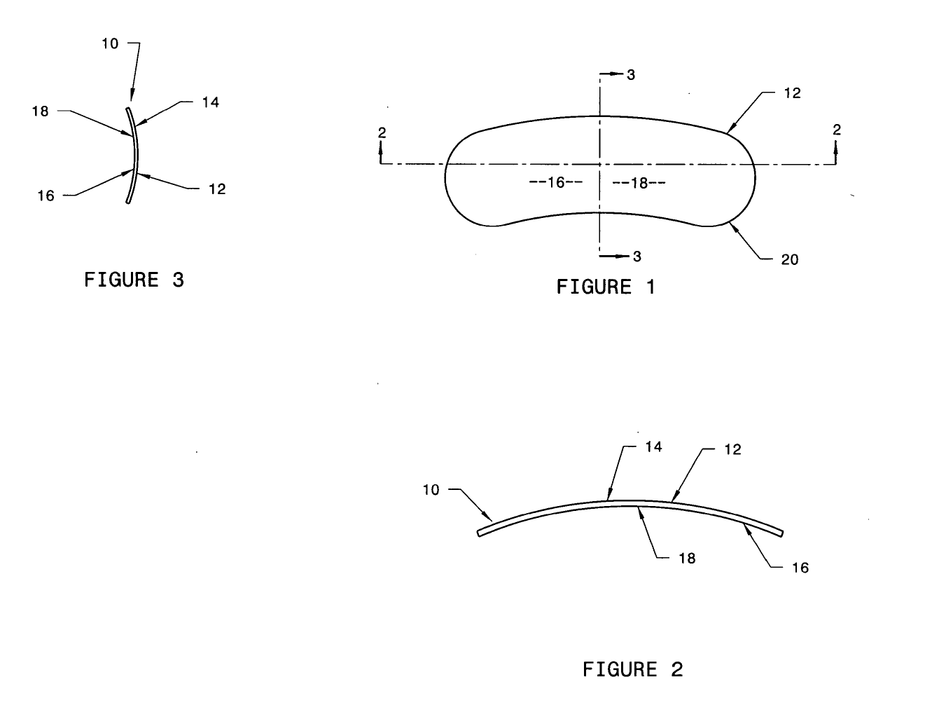

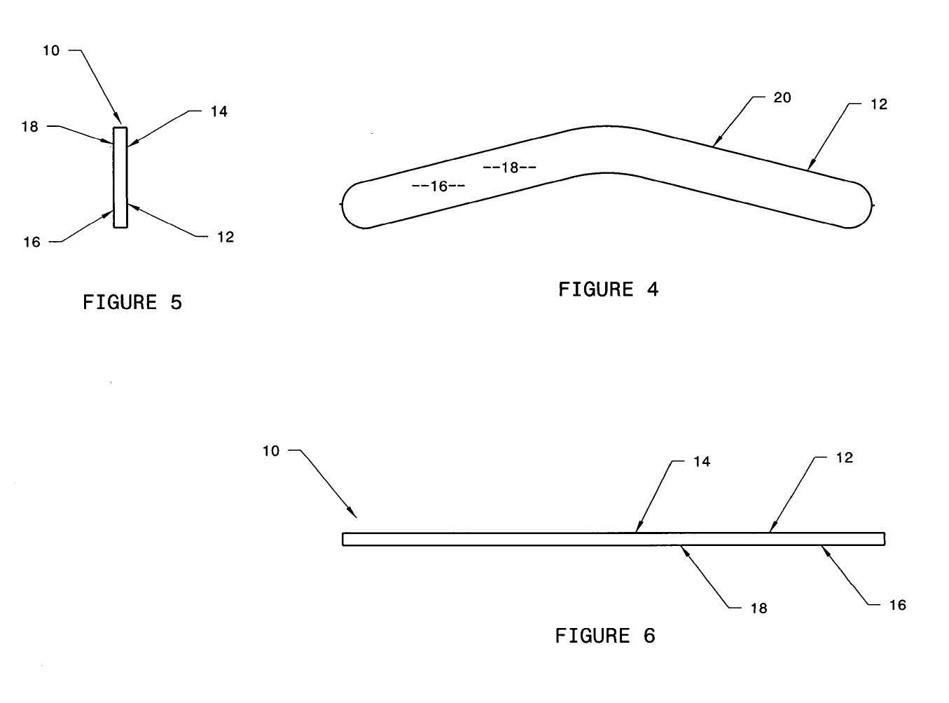

Referring now to the drawings and in particular to FIG. 1, the matrix band for dental applications is shown generally at 10. The matrix band is typically positioned around the tooth that is to be reconstructed through well known means. Certain of the matrix bands, as shown in FIG. 1 comprise a generally elliptical configuration which includes a concave inward surface. Such bands are positioned proximate the tooth by the dental practitioner. In other embodiments, such as the embodiment shown in FIG. 4, matrix bands may comprise elongated planar bands that are manipulated in conjunction with tools to wrap around the entire tooth. The present disclosure is equally applicable to either one of the commonly used matrix bands.

Generally, and with reference to FIGS. 1 through 3 collectively, matrix band 10 includes base material 12 having outer surface 14 and tooth contact surface 16. The base material includes perimeter 20. Preferably, the base material comprises a stainless steel which is commonly used for dental applications. In other embodiments, a polymer material may be utilized, or another metal or alloy thereof. For example, in certain embodiments, a PET material may be utilized for the base material. In other embodiments, the base material may comprise aluminum or an aluminum alloy. In certain applications, the metal may be plated or coated with another metal or material.

With the embodiment of FIGS. 1-3, the tooth contact surface comprises a convex surface which is configured so as to follow the contours of a tooth that is intended for restoration. In the embodiment of FIGS. 4-6, the band comprises an elongated planar material of substantially uniform width.

The coating 18 is applied to the tooth contact surface 16. In the embodiment shown, the entirety of the tooth contact surface 16 is coated with the coating. Preferably, the coating extends to the entirety of the tooth contact surface to the perimeter of the base material. The coating comprises a combination of fluorinated ethylene propylene (FEP), polytetrafluoroethylene (PTFE) and polyether sulfone (PES). Surprisingly, whereas other PTFE coatings have been tried without success, it has been found that the foregoing combination of materials yields a coating that can be utilized in the foregoing application without flaking, degradation or de-lamination proximate the perimeter of the base material. This has been found to be the case even after several autoclaving cycles. Additionally, the coating of the present disclosure can be applied prior to forming the matrix bands, even wherein the matrix bands are punched into the inwardly concave configuration of the embodiment shown in FIG. 1. Moreover, the coatings are resistant to adhesion of the bonding agents and restorative materials that are used in tooth restoration.

Preferably, the coating is applied through a number of different means. For example, the coating can be applied through spray or coil coating. Once applied, the coating can be cured in ovens. It is preferred that the coating be applied to a thickness of approximately between 0.00015 inches and 0.0006 inches. Additionally, a number of different pigments can be introduced into the coating so as to provide a number of different colors. The colors can be used as indicators of different properties of the respective matrix bands. Among other colors, it is contemplated that Red, Orange, White, Blue, Black, Purple, Grey, Green and Yellow can be utilized. Of course, other colors and color combinations are contemplated.

Preferably, to manufacture the matrix bands of the type shown in FIG. 1, a sheet of the base material is provided. Generally, as set forth above, the base material comprises a stainless steel. The base material is cleaned and then coated with the coating. Typically, the coating is applied to the base material in the desired thickness. Once applied, the coating is then cured.

The base material in sheet form with the coating applied thereto is then processed and shaped to make the final matrix bands. For the matrix bands shown in FIG. 1, the matrix bands are punched into the final shape. For planar matrix bands, such bands may be punched or cut into the final configuration. In other embodiments, the coating may be made initially, with the steps of cutting and forming occurring after the step of coating.

The foregoing description merely explains and illustrates the invention and the invention is not limited thereto except insofar as the appended claims are so limited, as those skilled in the art who have the disclosure before them will be able to make modifications without departing from the scope of the invention.

The embodiments of the invention in which an exclusive property or privilege is claimed are defined as follows:

1. A method of manufacturing a matrix band for dental applications comprising:
providing a base material in a first configuration in the form of a sheet;
coating the base material in the first configuration in the form of the sheet with a coating, the coating comprising fluorinated ethylene propylene, polytetrafluoroethylene and polyether sulfone; and
forming the base material into a second configuration, different from the first configuration in the form of the sheet, the second configuration in the form of an elongated band sized and shaped so that the elongated band can be wrapped around a tooth,
wherein the forming step is performed after the coating step,
wherein the forming step comprises defining a perimeter around the elongated band, the perimeter disposed around a tooth contact surface and an opposing outer surface,
wherein the coating is disposed on the tooth contact surface,
wherein the coating does not flake, degrade or delaminate proximate the perimeter during the forming step.

2. The method of claim 1 comprising curing the coating on the base material in the first configuration in the form of the sheet before the forming step.

3. The method of claim 2 wherein the base material in the second configuration is in the form of an elongated planar band.

4. The method of claim 2 wherein the forming step comprises punching the base material into the second configuration so that the elongated band attains an inwardly convex shape.

5. The method of claim 4 wherein the coating step comprises applying the coating to thickness of between 0.00015 inches and 0.0006 inches.

6. The method of claim 5 wherein the coating includes a pigment indicative of a matrix band property, whereby a user can select a particular matrix band based on color.

7. The method of claim 4 wherein the coating is on the tooth contact surface but not the opposing outer surface.

8. The method of claim 7 wherein the coating consists essentially of fluorinated ethylene propylene, polytetrafluoroethylene, polyether sulfone and at least one pigment.

9. The method of claim 1 wherein the coating consists essentially of fluorinated ethylene propylene, polytetrafluoroethylene, polyether sulfone and at least one pigment.

10. The method of claim 9 wherein the coating is resistant to adhesion of at least one of a bonding agent and a restorative material.

11. The method of claim 1 wherein the coating joins with the elongated band so that the coating does not flake, degrade or delaminate from the elongated band after the elongated band is subjected to cleaning by a third party.

12. The method of claim 11 wherein the cleaning includes autoclaving the matrix band.

13. A method of manufacturing a matrix band for dental applications comprising:
providing a planar sheet of base material being at least one of metal, alloy and polymer;
spraying a coating on the planar sheet, the coating comprising fluorinated ethylene propylene, polytetrafluoroethylene and polyether sulfone;
curing the coating on the planar sheet to form a cured coating;
stamping the sheet, having the cured coating thereon, so that at least one elongated band is punched from the planar sheet with the elongated band having a tooth contacting surface and an inwardly concave shape, the elongated band sized and shaped to wrap around a tooth, with the cured coating being disposed on the tooth contacting surface,
wherein the cured coating does not flake, degrade or delaminate from the sheet or elongated band during the stamping step,
wherein the cured coating is sufficiently joined with elongated band so that the coating does not flake, degrade or delaminate from the elongated band after the elongated band is subjected to at least one of physical manipulation, deformation and cleaning by a third party during use.

14. The method of claim 13 wherein the curing comprises baking the coating.

15. The method of claim 14 wherein the coating consists of fluorinated ethylene propylene, polytetrafluoroethylene, polyether sulfone and at least one pigment.

16. The method of claim 13 wherein the coating consists essentially of fluorinated ethylene propylene, polytetrafluoroethylene, polyether sulfone and at least one pigment.

17. The method of claim 13 wherein the spraying step comprises applying the coating to a thickness of between 0.00015 inches and 0.0006 inches.

18. The method of claim 17 wherein the elongated band defines a length and a width, the width being substantially uniform.

19. The method of claim 13 wherein the elongated band is of an elliptical configuration.
